(19) United States
(12) Patent Application Publication
(10) Pub. No.: US 2025/0164009 A1
(43) Pub. Date: May 22, 2025

(54) GASKET FOR PLUMBING ASSEMBLY

(71) Applicant: Zurn Water, LLC, Milwaukee, WI (US)

(72) Inventors: Christopher J. Say, Milwaukee, WI (US); Britney Shaw, Milwaukee, WI (US); Matthew C. Henderson, Milwaukee, WI (US)

(21) Appl. No.: 18/949,698

(22) Filed: Nov. 15, 2024

Related U.S. Application Data
(60) Provisional application No. 63/599,866, filed on Nov. 16, 2023.

(51) Int. Cl. F16J 15/08; E03D 11/14

(52) U.S. Cl. CPC F16J 15/0818; E03D 11/14

(57) ABSTRACT

A gasket is provided to create a seal between plumbing fittings. A gasket is configured to be positioned adjacent a surface of a fitting. The gasket includes a body, a hole, and a retainer. The body has a first side and a second side opposite the first side. At least one of the first side and the second side are configured to engage the surface of the fitting. The hole is configured to be aligned with a fastener hole of the fitting. The hole extends between the first side and the second side. The retainer is positioned adjacent the hole and configured to engage a portion of the fitting. The retainer is configured to bias the body against the surface of the fitting.

### CROSS-REFERENCE TO RELATED APPLICATION

This application claims the benefit of U.S. Provisional Patent Application No. 63/599,866 filed Nov. 16, 2023, the entire contents of which is incorporated by reference herein.

### TECHNICAL FIELD

The present application relates to a gasket, particularly to a gasket for a plumbing assembly (e.g., a water closet carrier assembly).

In some plumbing assemblies, a first fitting (e.g., an outlet pipe) is secured to a second fitting (e.g., a water closet carrier) and a gasket is positioned between the first fitting and the second fitting.

### SUMMARY

In one independent aspect, a gasket is configured to be positioned adjacent a surface of a fitting and the gasket includes a body, a hole, and a retainer. The body has a first side and a second side opposite the first side, and at least one of the first side and the second side is configured to engage the surface of the fitting. The hole is configured to be aligned with a fastener hole of the fitting, and the hole extends between the first side and the second side. The retainer is positioned adjacent the hole and configured to engage a portion of the fitting, and the retainer is configured to bias the body against the surface of the fitting.

In some aspects, the body includes an opening configured be aligned with a fluid opening of the fitting, the body configured to seal the fluid opening.

In some aspects, the retainer is a resilient strip that extends at least partially around the hole and is movable relative to the hole.

In some aspects, the body includes a peripheral edge and an ear protruding from the peripheral edge, wherein the hole extends through the ear.

In some aspects, the ear is configured to align with a lug of the fitting, wherein the retainer is movable to wrap around a portion of the lug.

In some aspects, the retainer is a resilient strip that extends along an outer edge of the ear.

In some aspects, the retainer, the ear, and the body are formed from a single piece of resilient material.

In some aspects, the retainer is movable between a first position and a second position, wherein, while the retainer is in the first position, the retainer is oriented in a common plane with the body and, while the retainer is in the second position, the retainer is not aligned with the plane of the body and engages the portion of the fitting.

In some aspects, the retainer includes a tab to facilitate grasping the retainer to move the retainer from a first position to a second position.

In some aspects, the retainer is capable of being positioned in a common plane with the body, thereby facilitating stacking of multiple gaskets.

In another independent aspect, a water closet carrier assembly includes a carrier, an outlet pipe, and a gasket. The carrier includes a carrier surface and a carrier outlet extending through the surface, and the carrier outlet is configured to be in fluid communication with a water closet. The outlet pipe includes a flange and a pipe opening. The flange is secured to the carrier, and the pipe opening is aligned with the carrier outlet and in fluid communication with the carrier outlet. The gasket is positioned between the carrier and the outlet pipe, and the gasket seals the carrier outlet and the pipe opening. The gasket includes a body, an opening, and a retainer. The body has a first side and a second side opposite the first side. The first side is positioned adjacent the carrier surface, and the second side is positioned adjacent the flange. The opening is aligned with the carrier outlet and the pipe opening. The retainer is engageable with one of the flange and the carrier surface to support the retainer relative to the one of the flange and the carrier surface.

In some aspects, the water closet carrier assembly further includes a fastener extending between the carrier and the flange through a hole in the gasket.

In some aspects, the body includes a peripheral edge and an ear protruding from the peripheral edge, wherein the hole extends through the ear, wherein the flange includes a lug including a flange hole that is aligned with the hole of the ear, the fastener extending through the flange hole and the hole of the ear, wherein the retainer is movable to wrap around the lug.

In some aspects, the retainer is a resilient strip that extends along an outer edge of the ear.

In some aspects, the retainer, the ear, and the body are formed from a single piece of resilient material and are oriented in a common plane.

In some aspects, the retainer is a resilient strip that forms a loop and extends from an outer peripheral edge of the gasket body, the retainer being movable relative to the body.

In some aspects, the retainer is movable between a first position and a second position, wherein, while the retainer is in the first position, the retainer is oriented in a common plane with the body and, while the retainer is in the second position, the retainer is not aligned with the plane of the body and engages a portion of the flange.

In some aspects, the retainer includes a tab to facilitate grasping the retainer to move the retainer from a first position to a second position.

In some aspects, the retainer is capable of being positioned in a common plane with the body, thereby facilitating stacking of multiple gaskets.

In yet another independent aspect, a method for installing a plumbing assembly includes: aligning a gasket with a flange of a first plumbing fitting; positioning a side of the gasket in an aligned position against the flange; moving a retainer of the gasket from a first position to a second position in which the retainer extends around a portion of the flange, the retainer biasing the gasket to remain in the aligned position; positioning another side of the gasket against a surface of a second plumbing fitting; and securing the first plumbing fitting relative to the second plumbing fitting, the gasket compressed between the first plumbing fitting and the second plumbing fitting

Other aspects of the disclosure will become apparent by consideration of the detailed description and accompanying drawings.

### BRIEF DESCRIPTION OF THE DRAWINGS

FIG. 1A is a plan view of a gasket according to one embodiment.

FIG. 1B is a perspective view of the gasket of FIG. 1A.

FIG. 2 is an exploded perspective view of the gasket of FIG. 1A and an outlet pipe.

FIG. 3 is a perspective view of the gasket of FIG. 1A positioned adjacent the outlet pipe.

FIG. 4 is a perspective view of the gasket of FIG. 1A coupled to the outlet pipe.

FIG. 5 is an enlarged perspective view of portion 5-5 of the gasket and outlet pipe of FIG. 4.

FIG. 6 is a plan view of a gasket according to another embodiment.

### DETAILED DESCRIPTION

Before any embodiments are explained in detail, it is to be understood that the disclosure is not limited in its application to the details of the configuration and arrangement of components set forth in the following description or illustrated in the accompanying drawings. The disclosure is capable of being practiced or of being carried out in various ways. Also, it is to be understood that the phraseology and terminology used herein are for the purpose of description and should not be regarded as limiting. The use of “including,” “comprising,” or “having” and variations thereof are meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings.

In general, the disclosure relates to a gasket 4 for sealing a connection for a plumbing assembly. For example, the gasket 4 may be positioned between two plumbing fittings (for example, a water closet carrier (not shown) and an outlet pipe 38). The gasket 4 includes one or more features to retain the gasket 4 on one of the plumbing fittings (e.g., to maintain the gasket 4 in place during assembly of the plumbing components).

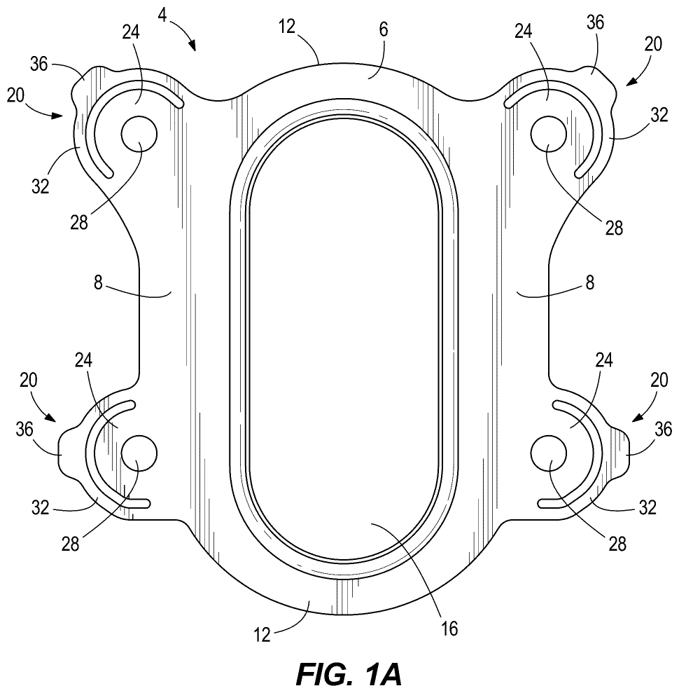

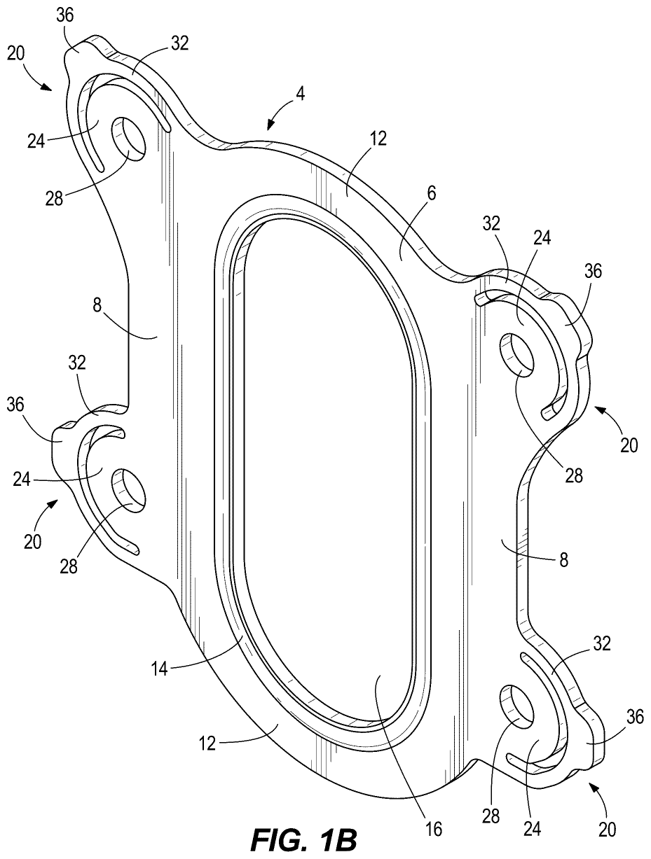

As shown in FIGS. 1A and 1B, the gasket 4 includes a gasket body 6. In the illustrated embodiment, the gasket 4 is a substantially planar body having a first side and a second side. In the illustrated embodiment, the gasket 4 includes an opening 16 extending between the first side and the second side, and ears 20 are positioned adjacent a peripheral edge of the body 6. The gasket 4 may also include one or more ridges 14 extending along the opening 16. The ridges 14 may protrude from the first side and/or the second side. The ridge(s) 14 sealingly engage the surfaces of the plumbing components; for example, the ridge 14 on a first side may sealingly engage a surface of a water closet carrier (not shown), and/or a ridge 14 on a second side of the gasket body 6 may sealingly engage a surface of outlet pipe 38.

In the illustrated embodiment, the opening 16 has geometric stadium or obround shape, and the gasket body 6 extends around the opening 16. The gasket body 6 may include a pair of substantially straight portions 8 positioned adjacent the opposite straight sides of the opening 16, and a pair of arcuate portions 12 positioned adjacent the curved ends of the opening 16. In other embodiments, the gasket body 6 may have a different shape and/or the opening 16 may have a different shape.

In the illustrated embodiment, each ear 20 is formed as a lobe that protrudes from the perimeter of the gasket body 6 and has an arcuate (e.g., semi-circular) outer profile. Each ear 20 includes a fastener connection region 24 that extends around a hole 28 (e.g., for receiving a fastener). In the illustrated embodiment, the gasket body 6 includes four ears 20 positioned around an outer peripheral edge of the body 6. The ears 20 may be positioned adjacent a transition between the straight portions 8 and the arcuate portions 12 of the gasket body 6. The ears 20 are oriented in a common plane with the body 6. In other embodiments, the gasket body 6 may include a fewer or more ears and/or may include ears having a different positioned and/or shape.

The gasket 4 may be formed from a resilient material (e.g., rubber, plastic, or another material) and the features of the gasket 4 may have a uniform thickness. The gasket 4 may facilitate the use of simple manufacturing processes (e.g., stamping, punching, etc.) on a sheet of material, while also facilitating sealing engagement once the gasket 4 is assembled between the plumbing components.

The gasket 4 further includes retainers 32. In the illustrated embodiment, each retainer 32 is positioned adjacent to and extends along an outer edge of an associated one of the ears 20 (e.g., an outer edge of the fastener connection region 24. Each retainer 32 may be formed as a narrow strip or loop of material that is oriented in the same plane as the gasket body 6 and follows the profile of the outer edge of the ear 20. In some embodiments, each retainer 32 may include a tab 36 (e.g., a portion having a larger width than the rest of the retainer 32) to facilitate grasping and movement of the retainer 32 relative to the rest of the gasket body 6.

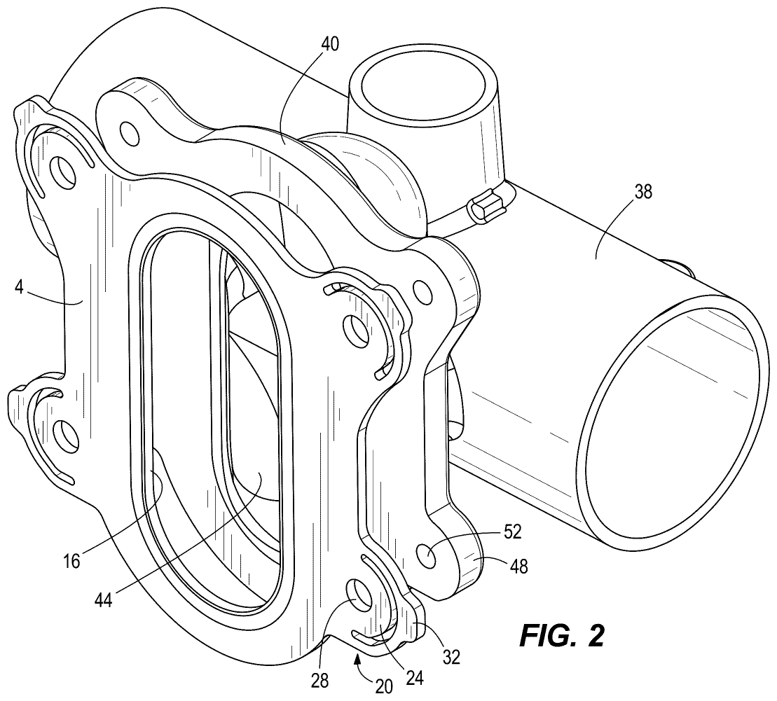

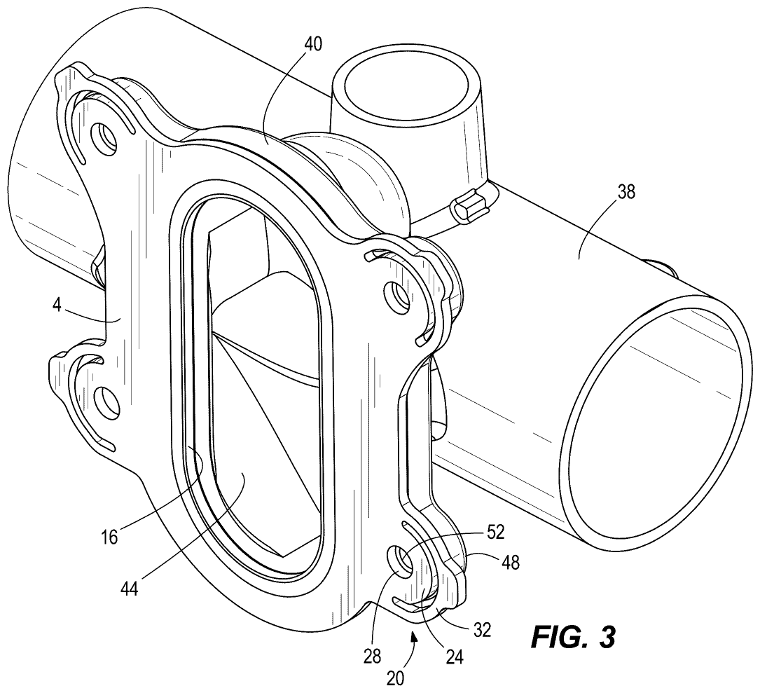

As shown in FIGS. 2 and 3, the gasket 4 (or at least, the portions of the gasket 4 other than the retainers 32) may have a profile that is substantially similar to an interface between the water closet carrier and the outlet pipe 38. For example, the shape of the gasket body 6, the opening 16, and the ears 20 may be substantially the same as a flange 40 of the outlet pipe 38. The flange 40 may include a fitting opening 44 that is aligned with the opening 16, as well as lugs 48 that are aligned with the ears 20 of the gasket 4. The flange 40 may further include fitting holes 52 that are aligned with the holes 28 of the ears 20.

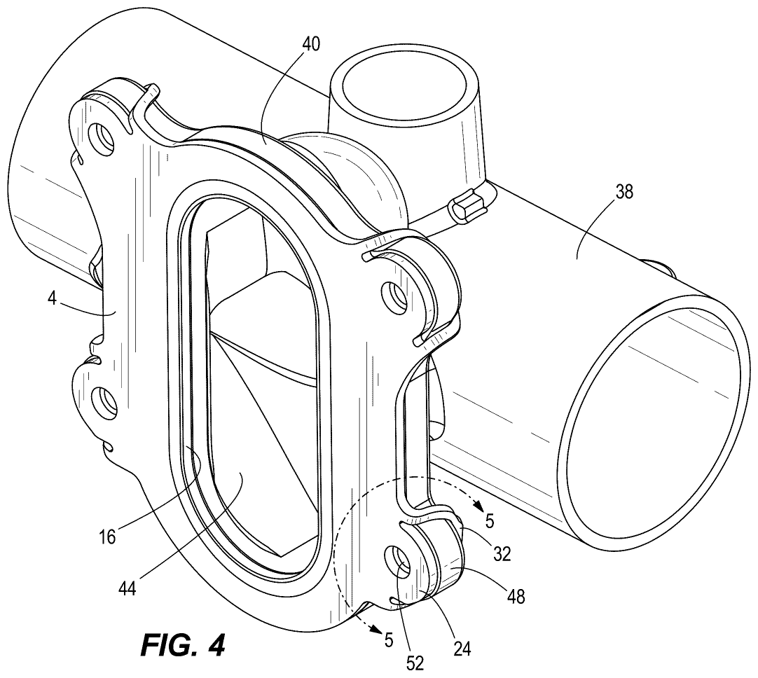

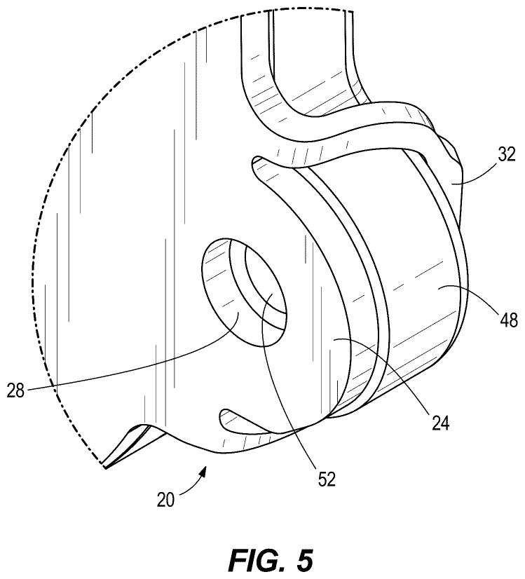

As shown in FIG. 3, the retainers 32 are initially oriented in the same plane as the gasket body 6 when the gasket 4 is initially positioned adjacent the flange 40. In other embodiments, the fabricated gasket may include the gasket body and ears oriented in a plane, and the retainers may be oriented at an angle relative to the plane of the gasket body and ears. As shown in FIGS. 4 and 5, one or more retainers 32 may be moved (e.g., deflected) to a second position in which the retainer 32 engages a portion of the outlet pipe 38 (e.g., an associated lug 48). For example, in the illustrated embodiment, each retainer 32 may wrap around or extend around a side of the associated lug 48 opposite the gasket 4 while connected to the gasket body 6, thereby biasing the gasket 4 against the flange 40. Accordingly, the retainer 32 assists in maintaining the gasket 4 in the desired, aligned position on the flange 40 at least during the assembly process. In some embodiments, the gasket 4 is made from a resilient or flexible material, and each retainer 32 may elastically deform or stretch to extend around the associated lug 48. In the embodiment shown, the retainers 32 extend around the lugs 48; in other embodiments, the retainers 32 may engage a different feature (e.g., a protrusion or other surface) of the outlet pipe 38.

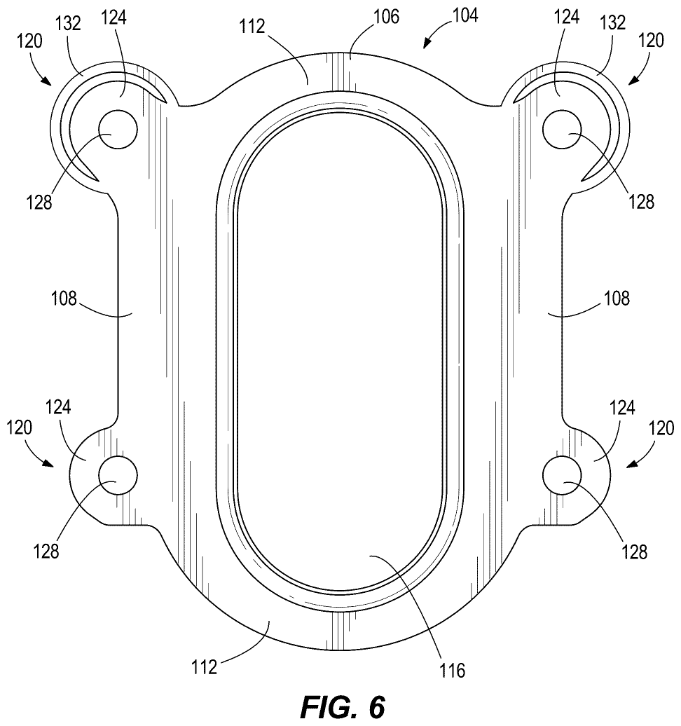

Although the gasket 4 is illustrated and described as having four ears 20 and four retainers 32, in other embodiments a gasket may have different number of ears and retainers. For example, as shown in FIG. 6, a gasket 104 may include four ears 120 and two retainers 132. In the illustrated embodiment, the retainers 132 are positioned adjacent ears 120 that are located on opposite ends and opposite sides from one another with respect to an opening 116. In other embodiments, fewer or more retainers may be included and/or may be located adjacent any portion(s) of the gasket to sufficiently maintain the gasket in alignment with the flange 40.

The gasket 4 illustrated in FIGS. 1-5 may be positioned between the outlet pipe 38 and a water closet carrier or other structure. In some embodiments, the water closet carrier is positioned behind a finished wall to support a toilet or urinal. The carrier includes an outlet for conveying wastewater from the water closet. During installation, the water closet carrier is secured to the outlet pipe 38 to provide fluid communication between the carrier outlet, the opening 16, and the fitting opening 44. Fasteners (not shown) are inserted through the carrier, through the holes 28 of the gasket 4, and into the hole 52 of the flange 40 and the gasket 4 is compressed to form a sealed, watertight connection between the fitting 38 and carrier. In some circumstances, the carrier, the outlet pipe 38, and other components of the assembly can be large and heavy, making assembly of the components difficult and/or requiring multiple technicians to complete installation. The retainers 32 maintain the gasket 4 in a desired position while the components are assembled. Although the retainers 32 in the illustrated embodiment engage and extend around the lugs 48 of the outlet pipe 38, in some embodiments the gasket may include retainers that are configured to engage one or more portions of the carrier, thereby maintaining the gasket in a desired position relative to the carrier.

In an unassembled state, the retainers 32, 132 are oriented in the same plane as the rest of the gasket 4, 104, thereby providing a gasket having a low profile. Moreover, multiple gaskets 4, 104 can easily be stacked on top of one another to simplify storage, packaging, and transportation of the gaskets 4, 104. During assembly, the gasket 4, 104 is aligned with the flange 40 (e.g., by aligning the opening 16, 116 with the fitting opening 44, aligning the holes 28, 128 with the fitting holes 52). The retainers 32, 132 are grasped (e.g., either directly or at the tabs 36) and moved from a first position (e.g., an undeformed position) aligned with the gasket body 6, 106 to a second position (e.g., a deformed position) in which the retainers 32, 132 wrap around a side of the lugs 48 opposite the gasket 4, 104. At this point, the gasket 4, 104 remains in place without additional user intervention. The outlet pipe 38 may then be positioned against the carrier or other component(s), and fasteners may be inserted through the holes 28, 128, and fitting holes 52 and tightened to form a sealed coupling.

Although the gasket 4, 104 is described and illustrated in the context of a water closet carrier assembly, it is understood that the gasket 4, 104 may be used in other types of sealed couplings and assemblies.

The embodiment(s) described above and illustrated in the figures are presented by way of example only and are not intended as a limitation upon the concepts and principles of the present disclosure. As such, it will be appreciated that variations and modifications to the elements and their configuration and/or arrangement exist within the spirit and scope of one or more independent aspects as described.

What is claimed is:

1. A gasket configured to be positioned adjacent a surface of a fitting, the gasket comprising:
a body having a first side and a second side opposite the first side, at least one of the first side and the second side configured to engage the surface of the fitting;
a hole configured to be aligned with a fastener hole of the fitting, the hole extending between the first side and the second side; and
a retainer positioned adjacent the hole and configured to engage a portion of the fitting, the retainer configured to bias the body against the surface of the fitting.

2. The gasket of claim 1, wherein the body includes an opening configured be aligned with a fluid opening of the fitting, the body configured to seal the fluid opening.

3. The gasket of claim 1, wherein the retainer is a resilient strip that extends at least partially around the hole and is movable relative to the hole.

4. The gasket of claim 1, wherein the body includes a peripheral edge and an ear protruding from the peripheral edge, wherein the hole extends through the ear.

5. The gasket of claim 4, wherein the ear is configured to align with a lug of the fitting, wherein the retainer is movable to wrap around a portion of the lug.

6. The gasket of claim 4, wherein the retainer is a resilient strip that extends along an outer edge of the ear.

7. The gasket of claim 6, wherein the retainer, the ear, and the body are formed from a single piece of resilient material.

8. The gasket of claim 1, wherein the retainer is movable between a first position and a second position, wherein, while the retainer is in the first position, the retainer is oriented in a common plane with the body and, while the retainer is in the second position, the retainer is not aligned with the plane of the body and engages the portion of the fitting.

9. The gasket of claim 1, wherein the retainer includes a tab to facilitate grasping the retainer to move the retainer from a first position to a second position.

10. The gasket of claim 1, wherein the retainer is capable of being positioned in a common plane with the body, thereby facilitating stacking of multiple gaskets.

11. A water closet carrier assembly comprising:
a carrier including a carrier surface and a carrier outlet extending through the surface, the carrier outlet configured to be in fluid communication with a water closet;
an outlet pipe including a flange and a pipe opening, the flange secured to the carrier, the pipe opening aligned with the carrier outlet and in fluid communication with the carrier outlet; and
a gasket positioned between the carrier and the outlet pipe, the gasket sealing the carrier outlet and the pipe opening, the gasket including:
a body having a first side and a second side opposite the first side, the first side positioned adjacent the carrier surface, the second side positioned adjacent the flange,
an opening aligned with the carrier outlet and the pipe opening, and
a retainer engageable with one of the flange and the carrier surface to support the retainer relative to the one of the flange and the carrier surface.

12. The water closet carrier assembly of claim 11, further comprising a fastener extending between the carrier and the flange through a hole in the gasket.

13. The water closet carrier assembly of claim 12, wherein the body includes a peripheral edge and an ear protruding from the peripheral edge, wherein the hole extends through the ear, wherein the flange includes a lug including a flange hole that is aligned with the hole of the ear, the fastener extending through the flange hole and the hole of the ear, wherein the retainer is movable to wrap around the lug.

14. The water closet carrier assembly of claim 13, wherein the retainer is a resilient strip that extends along an outer edge of the ear.

15. The water closet carrier assembly of claim 14, wherein the retainer, the ear, and the body are formed from a single piece of resilient material and are oriented in a common plane.

16. The water closet carrier assembly of claim 11, wherein the retainer is a resilient strip that forms a loop and extends from an outer peripheral edge of the gasket body, the retainer being movable relative to the body.

17. The water closet carrier assembly of claim 11, wherein the retainer is movable between a first position and a second position, wherein, while the retainer is in the first position, the retainer is oriented in a common plane with the body and, while the retainer is in the second position, the retainer is not aligned with the plane of the body and engages a portion of the flange.

18. The water closet carrier assembly of claim 11, wherein the retainer includes a tab to facilitate grasping the retainer to move the retainer from a first position to a second position.

19. The water closet carrier assembly of claim 11, wherein the retainer is capable of being positioned in a common plane with the body, thereby facilitating stacking of multiple gaskets.

20. A method for installing a plumbing assembly, the method comprising:
aligning a gasket with a flange of a first plumbing fitting;
positioning a side of the gasket in an aligned position against the flange;
moving a retainer of the gasket from a first position to a second position in which the retainer extends around a portion of the flange, the retainer biasing the gasket to remain in the aligned position;
positioning another side of the gasket against a surface of a second plumbing fitting; and
securing the first plumbing fitting relative to the second plumbing fitting, the gasket compressed between the first plumbing fitting and the second plumbing fitting.
